(19) United States
(12) Patent Application Publication
(10) Pub. No.: US 2015/0022812 A1
(43) Pub. Date: Jan. 22, 2015

(54) INSPECTION APPARATUS

(71) Applicant: NuFlare Technology, Inc., Yokohama (JP)

(72) Inventor: Riki OGAWA, Kanagawa (JP)

(73) Assignee: NuFlare Technology, Inc., Yokohama (JP)

(21) Appl. No.: 14/332,592

(22) Filed: Jul. 16, 2014

(30) Foreign Application Priority Data
Jul. 19, 2013 (JP) 2013-151157

(51) Int. Cl. G01N 21/956; G01N 21/21

(52) U.S. Cl. CPC G01N 21/956; G01N 21/21; G01N 2021/95676
USPC 356/364

(57) ABSTRACT

An inspection apparatus comprising, a light source configured to illuminate a sample, a half-wavelength plate configured to transmit light transmitted through or reflected from the sample, a polarization beamsplitter, a first and second sensor configured to receive the light as a first and second optical image respectively transmitted through the beamsplitter, an image processor configured to obtain a gradation value of each pixel of the first sensor, a defect detector configured to detect a defect of the first optical image, using the gradation value, and a comparator configured to compare the second optical image to a reference image based on design data, and to determine that the second optical image is defective when at least one difference of position and shape between the optical image and the reference image exceeds a predetermined threshold, and an angle adjusting unit configured to adjust an angle of the half-wavelength plate.

### CROSS-REFERENCE TO THE RELATED APPLICATION

The entire disclosure of the Japanese Patent Application No. 2013-151157, filed on Jul. 19, 2013 including specification, claims, drawings, and summary, on which the Convention priority of the present application is based, are incorporated herein in its entirety.

### FIELD OF THE INVENTION

The present invention relates to an Inspection Apparatus.

### BACKGROUND

Nowadays, with increasing integration degree of a semiconductor device, dimensions of individual elements have become finer, and widths of wiring and gates constituting each element have also become finer.

A process of transferring an original plate (a mask or a reticle, hereinafter collectively referred to as a mask) to a photosensitive resin to fabricate a wafer is fundamental to production of a semiconductor integrated circuit. The semiconductor integrated circuit is produced by repeating this fundamental process.

An exposure apparatus called a stepper or a scanner is used in the transfer process. In the exposure apparatus, light is used as a transfer light source and a circuit pattern on the reticle is projected onto the wafer while reduced to about one- fourth to about one-fifth size. In order to increase the integration degree of the semiconductor integrated circuit, it is necessary to improve resolution performance in the transfer process. If NA is a numerical aperture of an imaging optical system, and λ is a wavelength of the light source, a resolution dimension is proportional to λ/NA. Accordingly, higher exposure resolution can be achieved by increasing the numerical aperture NA or decreasing the wavelength λ.

As another example for the higher exposure resolution, nanoimprint lithography (NIL) has attracted attention as a technology for forming the fine pattern. In the nanoimprint lithography, a fine pattern is formed in a resist by pressuring a master template (a mold) having a nanometer-scale fine structure to the resist on the wafer. In the nanoimprint technology, in order to enhance productivity, plural duplicate templates (replica templates) are produced using a master template that is an original plate, and then the replica templates are attached to and used in each nanoimprint lithography apparatuses.

It is necessary to improve a production yield of the expensive LSI in a production process. A defect of a circuit pattern formed on of a mask or template can be cited as a large factor that reduces a production yield of the semiconductor element. It is necessary to detect the shape defect of the extremely small pattern in a mask inspection process. Japanese Patent Number 4236825 discloses an inspection apparatus that can detect fine defects in the mask.

In the mask inspection process, the mask is illuminated with the light while the mask is moved with a mask stage, and the pattern formed on the mask is imaged with an imaging element such as a CCD camera. Then, an obtained optical image is compared to a reference image, namely, an image that is compared to the optical image of a pattern in order to detect a defect, and a place where a difference between the optical image and the reference image exceeds a threshold is detected as a defect. The difference, for example, can be a difference of a line width of a pattern of the optical image and a line width of a pattern of the reference image.

Nowadays, with the progress of the fine circuit pattern, the pattern dimension is finer than the resolution of an optical system of the inspection apparatus. For example, when a width of a line pattern formed in the template is less than 50 nm, the pattern cannot be resolved with a light source of DUV (Deep UltraViolet radiation) light having a wavelength of about 190 nm to about 200 nm, which can be relatively easily constructed in the optical system. Therefore, the light source of an EB (Electron Beam) is used. However, unfortunately the light source of the EB is not suitable to perform high throughput of the mask inspection process.

Therefore, there is a demand for an inspection apparatus that can accurately inspect a fine pattern without generating the throughput degradation.

Additionally, the pattern formed on the mask does not have constant density. For example, a high-pattern-density region such as a memory mat and a low-pattern-density region such as a peripheral circuit are mixed with each other in a semiconductor chip. The former has the pattern of an optical resolution limit or less, and the latter has the pattern larger than the optical resolution limit. Therefore, an optical condition necessary for the inspection depends on the region on the mask.

In such cases, it is considered that two different optical conditions refers to, the optical condition used to inspect the pattern of the optical resolution limit or less and the optical condition used to inspect the pattern larger than the optical resolution limit. After the whole mask is inspected with one of the optical conditions, the whole mask is inspected again with the other optical condition. This means that two inspections are conducted on one mask. This causes a problem in that much time is needed for inspection.

The present invention has been made in view of such a problem. An object of the present invention is to provide an inspection apparatus that can accurately inspect the fine pattern without generating the throughput degradation, and inspect a mask with the pattern of the optical resolution limit or less and the pattern larger than the optical resolution limit using only one inspection process.

Other advantages and challenges of the present invention are apparent from the following description.

### SUMMARY OF THE INVENTION

According to one aspect of the present invention, an inspection apparatus comprising, a light source configured to illuminate a sample which is an inspection target, a half-wavelength plate configured to transmit the light transmitted through or reflected from the sample, a polarization beamsplitter configured to transmit the light transmitted through the half-wavelength plate, a first sensor configured to receive the light as a first optical image transmitted through the polarization beamsplitter, a second sensor configured to receive the light as a second optical image reflected from the polarization beamsplitter, an image processor configured to obtain a gradation value of each pixel of the first sensor with respect to the first optical image captured with the first sensor, a defect detector configured to detect a defect of the first optical image captured with the first sensor, using the gradation value, and a comparator configured to compare the second optical image of a pattern captured with the second sensor to a reference image which is an image generated based on design data or an image captured by photographing the same pattern, and to determine that the second optical image is defective when at least one difference of position and shape between the optical image and the reference image exceeds a predetermined threshold, an angle adjusting unit configured to adjust an angle of the half-wavelength plate to control a polarization direction of the light incident to the first sensor.

Further to this aspect of the present invention, an inspection apparatus, wherein the light irradiated from the light source is linearly-polarized light, and a quarter-wavelength plate is arranged on an optical path toward the sample from the light source and another quarter wavelength plate is arranged on an optical path toward the half-wavelength plate from the sample.

Further to this aspect of the present invention, an inspection apparatus, wherein the light irradiated from the light source is linearly-polarized light, and a quarter-wavelength plate is arranged on a shared optical path, wherein the shared optical path is a section of an optical path toward the sample from the light source, and a section of an optical path toward the half-wavelength plate from the sample.

Further to this aspect of the present invention, an inspection apparatus, wherein the light irradiated from the light source is linearly-polarized light, and the half-wavelength plate is arranged on an optical path toward the sample from the light source.

Further to this aspect of the present invention, an inspection apparatus, wherein a light quantity adjustor is arranged on an optical path toward the second sensor from the polarization beamsplitter.

Further to this aspect of the present invention, an inspection apparatus, wherein the angle of the half-wavelength plate is set to one of an angle at which a standard deviation of the gradation value obtained by the image processor becomes the minimum and an angle at which a value in which the standard deviation of the gradation value, which is obtained while the angle of the half-wavelength plate is changed, is divided by a square root of an average gradation value obtained from the when the gradation value becomes the minimum.

Further to this aspect of the present invention, an inspection apparatus, wherein the defect detector compares the gradation value output from the image processor to a predetermined threshold, and detects the defect when the gradation value exceeds the threshold.

In another aspect of the present invention, an inspection apparatus comprising, a light source configured to illuminate a sample which is an inspection target, a branching element that branches the light emitted from the light source, a polarization beamsplitter configured to transmit the light transmitted through or reflected from the sample is incident, the light being one of light branched by the branching element, a first sensor configured to receive the light as a first optical image transmitted through the polarization beamsplitter, a second sensor configured to receive the light as a second optical image transmitted through or reflected from the sample, the second light being the other light branched by the branching element, an image processor configured to obtain a gradation value of each pixel of the first sensor with respect to the first optical image captured with the first sensor, a defect detector configured to detect a defect of the first optical image captured with the first sensor, using the gradation value, and a comparator configured to compares the second optical image of a pattern captured with the second sensor to a reference image which is an image generated based on design data or an image captured by photographing the same pattern, and to determine that the second optical image is defective when at least one difference of position and shape between the optical image and the reference image exceeds a predetermined threshold, an angle adjusting unit configured to adjust an angle of the polarization beamsplitter to control a polarization direction of the light incident to the first sensor.

Further to this aspect of the present invention, an inspection apparatus, wherein the light irradiated from the light source is linearly-polarized light, and a quarter-wavelength plate is arranged an optical path toward the sample from the branching element, and another quarter wavelength plate is arranged on an optical path toward the polarized beam splitter from the sample.

Further to this aspect of the present invention, an inspection apparatus, wherein the light irradiated from the light source is linearly-polarized light, and a quarter-wavelength plate is arranged on a shared optical path, wherein the shared optical path is a section of an optical path toward the sample from the branching element, and a section of an optical path toward the polarized beam splitter from the sample.

Further to this aspect of the present invention, an inspection apparatus, wherein a half-wavelength plate is arranged on an optical path toward the branching element from the light source, and a ratio of quantities of light branched by the branching element is adjusted by the angle of the half-wavelength plate.

Further to this aspect of the present invention, an inspection apparatus, wherein the angle of the polarized beam splitter is set to one of an angle at which a standard deviation of the gradation value obtained by the image processor becomes the minimum and an angle at which a value in which the standard deviation of the gradation value, which is obtained while the angle of the polarized beam splitter is changed, is divided by a square root of an average gradation value obtained from when the gradation value becomes the minimum.

Further to this aspect of the present invention, an inspection apparatus, wherein the defect detector compares the gradation value output from the image processor to a predetermined threshold, and detects the defect when the gradation value exceeds the threshold.

### BRIEF DESCRIPTION OF THE DRAWINGS

FIG. 1 illustrates an illumination optical system that illuminates a mask of the inspection target, and an imaging optical system that images the light reflected from the mask onto two sensors.

FIG. 2 illustrates an example of the short-circuit defect.

FIG. 3 illustrates an example of the open-circuit defect.

FIG. 4 shows the defect caused by edge roughness.

FIG. 5 schematically illustrates the line and space pattern provided in the mask.

FIG. 6 illustrates a state in which the pattern is subjected to the spatial frequency filter.

FIG. 7 illustrates an optical system according to a second embodiment.

FIG. 8 illustrates an example of an optical system according to a third embodiment.

FIG. 9 is a configuration diagram illustrating an inspection apparatus 100 of the fourth embodiment.

FIG. 10 is a view illustrating a procedure to acquire the optical image of the pattern formed in the sample.

### DETAILED DESCRIPTION OF THE EMBODIMENTS

### Embodiment 1

A short-circuit defect in which lines are short-circuited and an open-circuit defect in which the line is disconnected are detected in a pattern of an optical resolution limit or less. The short-circuit defect and the open-circuit defect have a large influence on a polarization state of illumination light. Therefore, by controlling the polarization state of the illumination light and an optical condition for a polarization control element of an optical system that images light reflected from an inspection target, bright and dark unevenness caused by edge roughness can be removed with the polarization control element thereby extracting only a change in amplitude of the short-circuit defect or open-circuit defect. However, this optical condition is not suitable for the inspection of a region where high contrast is required because a gradation value is lowered both in a white portion and a black portion of an optical image under the optical condition.

A dimension (Critical Dimension; hereinafter referred to as CD) of the pattern and the like are measured in the inspection of the pattern larger than the optical resolution limit. In this case, the inspection is facilitated with increasing contrast between the white portion and the black portion. However, using the optical condition, it is hard to remove the bright and dark unevenness caused by edge roughness to extract only a change in amplitude of the short-circuit defect or open-circuit defect. Therefore the short-circuit defect or open-circuit defect of the optical resolution limit or less is hardly distinguishable from the edge roughness. Accordingly the optical condition is not suitable for the inspection of the pattern of the optical resolution limit or less because the short-circuit defect or open-circuit defect of the optical resolution limit or less is hardly distinguishable from the edge roughness.

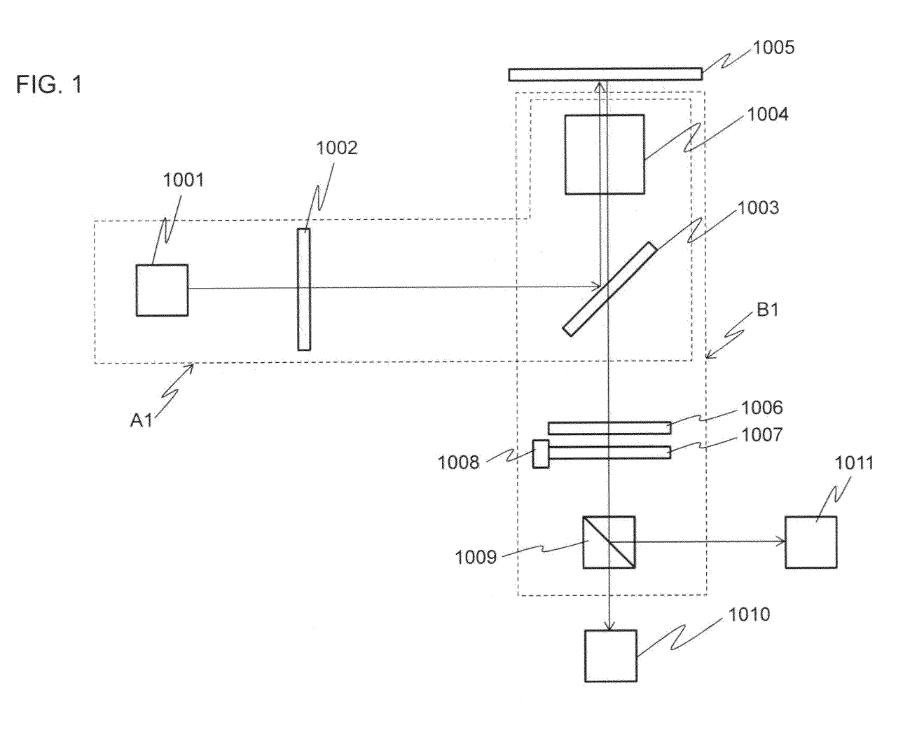

Thus, the optical condition used to inspect the pattern of the optical resolution limit or less differs from the optical condition used to inspect the pattern larger than the optical resolution limit. As a result, the present invention, that is, an optical system as shown in FIG. 1, for the purpose of inspecting the pattern using both optical conditions within one process, has been created. The inventor has found that the patterns can be inspected at one time using an optical system as shown in FIG. 1 as a result of intensive research.

FIG. 1 illustrates an illumination optical system Al that illuminates a mask 1005 of the inspection target and an imaging optical system B1 that images the light reflected from the mask 1005 onto two sensors 1010 and 1011. The sensor 1010 corresponds to the first sensor of the present invention, and the sensor 1011 corresponds to the second sensor of the present invention.

The illumination optical system Al includes a light source 1001, a quarter-wavelength plate 1002, a half mirror 1003, and an objective lens 1004. The imaging optical system B1 includes the objective lens 1004, the half mirror 1003, a quarter-wavelength plate 1006, a half-wavelength plate 1007, a rotation mechanism 1008, and a polarization beamsplitter 1009. The half mirror 1003 and the objective lens 1004 are shared by the illumination optical system Al and the imaging optical system B1.

A laser beam source can be used as the light source 1001 in FIG. 1. Generally the light emitted from the laser beam source is linearly-polarized light. In the first embodiment, the linearly-polarized light is changed into circularly-polarized light, and the mask 1005 is illuminated with the circularly-polarized light. Therefore, an optical image is obtained having a directionless resolution characteristic.

In the illumination optical system Al in FIG. 1, the linearly-polarized light emitted from the light source 1001 changes into the circularly-polarized light through the quarter-wavelength plate 1002. Then, the light, which is reflected by the half mirror 1003 irradiates the mask 1005 through the objective lens 1004. Thus, the mask 1005 is irradiated by the circularly-polarized light.

The light is reflected from the mask 1005 and focused as an optical image on the sensors 1010 and 1011 through the imaging optical system B1. Specifically, the light is sequentially transmitted through the objective lens 1004 and the half mirror 1003, and the light is changed again into the linearly-polarized light by the quarter-wavelength plate 1006. Then the linearly-polarized light is incident to the polarization beamsplitter 1009 after a polarization direction of the light is changed by the half-wavelength plate 1007. At this point, a quantity of p-polarized light incident to the polarization beamsplitter 1009 and a quantity of s-polarized light are adjusted by changing an angle of the half-wavelength plate 1007. The rotation mechanism 1008 is provided with the half-wavelength plate 1007, and the rotation mechanism 1008 can control the angle of the half-wavelength plate 1007. The angle of the half-wavelength plate can be converted into a rotation angle of the polarized light transmitted through the half-wavelength plate (hereinafter, this explanation can be applied to the whole specification).

The p-polarized light incident to the polarization beamsplitter 1009 is incident to the sensor 1010. The s-polarized light incident to the polarization beamsplitter 1009 is reflected by the polarization beamsplitter 1009 and is incident to the sensor 1011.

The sensors 1010 and 1011 capture the same optical image of the mask 1005. A high-pattern-density region such as a memory mat and a low-pattern-density region such as a peripheral circuit are mixed with each other in the mask 1005. The former has the pattern of the optical resolution limit or less, and the latter has the pattern larger than the optical resolution limit. In the first embodiment, the image captured with the sensor 1010 is used to inspect the pattern of the optical resolution limit or less. The image captured with the sensor 1011 is used to inspect the pattern larger than the optical resolution limit. Many patterns are repetitive patterns such as a line and space pattern which is namely a regular repetitive pattern having periodicity. For example, a template in nanoimprint lithography can also be used as the inspection target instead of the mask 1005. In this case there are frequent repetitive patterns in the template.

The image captured with the sensor 1010 will be described below.

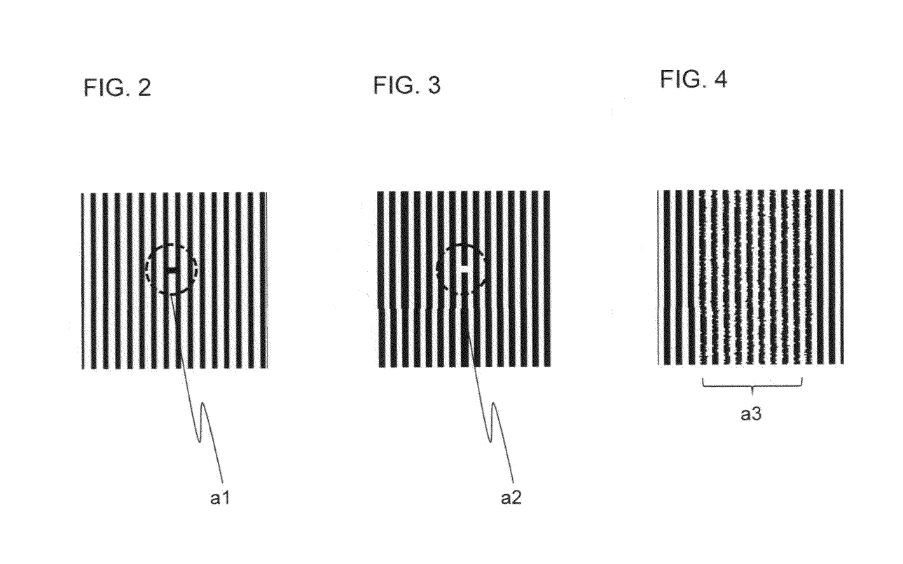

As mentioned above, a short-circuit defect in which lines are short-circuited and an open-circuit defect in which the line is disconnected are detected in a pattern of an optical resolution limit or less. FIG. 2 illustrates an example of the short-circuit defect. In a region a1, two lines adjacent to each other are connected to generate the short-circuit defect. FIG. 3 illustrates an example of the open-circuit defect. In a region a2, the line is partially disconnected. These defects have a serious influence on the performance of the mask.

As to another example of pattern defect, edge roughness becomes prominent as illustrated in a region a3 as shown in FIG. 4. However, this defect has a restricted influence on the performance of the mask unlike the short-circuit defect and the open-circuit defect.

Some defects become practically problematic, and some defects do not become practically problematic. Only the defect becoming practically problematic should be detected in the inspection. Specifically, it is necessary to defect the short-circuit defect and the open-circuit defect, but it is not necessary to defect the edge roughness. However, in the case that the short-circuit defect, the open-circuit defect, and the edge roughness having the size of the optical resolution limit or less are mixed in the pattern of the optical resolution limit or less, more particularly the repetitive pattern having a period of the optical resolution limit or less of the optical system in the inspection apparatus, in observation with the optical system, the brightness and darkness caused by the short-circuit defect or the open-circuit defect is not distinguished from the brightness and darkness caused by the edge roughness. This is because, in the optical image of the pattern, all of the defects, that is, the short-circuit defect, the open-circuit defect, and the edge roughness become blurred by the same amount, that is, these defects are expanded to the same size, namely, to about the optical resolution limit of size.

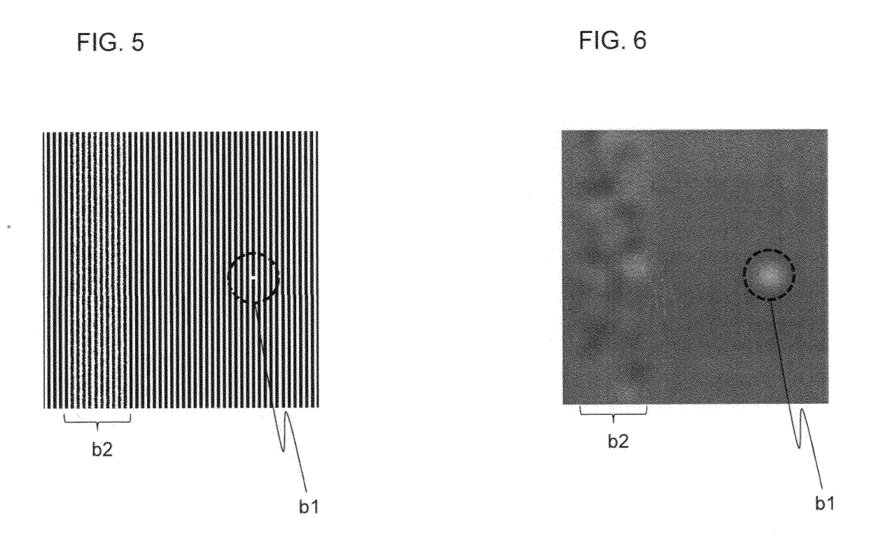

FIG. 5 schematically illustrates the line and space pattern provided in the mask 1005. In FIG. 5, it is assumed that the size of the pattern is smaller than the resolution limit of the optical system. In the region b1 in FIG. 5, the line pattern is partially lacking thus generating the open-circuit defect. In the region b2, the edge roughness of the line pattern becomes prominent. Although a difference of the defect between the open-circuit defect in the region b1 and the edge roughness in the region b2, is clearly recognized on the actual mask, the differences are hardly distinguished from each other by the observation through the optical system. This is because the optical system behaves as a spatial frequency filter defined by a wavelength λ of the light emitted from the light source and a numerical aperture NA.

FIG. 6 illustrates a state in which the pattern in FIG. 5 is subjected to the spatial frequency filter. As can be seen from FIG. 6, the defect in the region b1 and the defect in the region b2 are expanded to the similar size, and the shapes of the defects are hardly distinguishable from each other. Thus, in principle, the open-circuit defect of the optical resolution limit or less and the edge roughness are hardly distinguished from each other with the optical system. The same holds true for the short-circuit defect and the edge roughness.

The large defect such as the short-circuit defect and the open-circuit defect has the large influence on the polarization state of the illumination light compared with the small defect such as the defect caused by the edge roughness.

For example, in the short-circuit defect in FIG. 2, a vertical direction and a horizontal direction differ from each other in sensitivity for an electric field component of the illumination light when the adjacent lines are connected to each other.

For the sake of easy understanding, it is considered that the linearly-polarized light is perpendicularly incident to the mask. In the case that the linearly-polarized light has the polarization direction of 45 degrees with respect to a direction along an edge of the line and space pattern, while a vertical component and a horizontal component of the electric field of the incident light are equal to each other, a difference between the horizontal component and the vertical component of the electric field of the reflected light emerges due to the short-circuit defect. As a result, the polarization state of the light reflected from the short-circuit defect differs from that of the incident light.

On the other hand, for the defect caused by the edge roughness in FIG. 4, the lines are not connected to each other, and the lines are not disconnected. Because a size of irregularities in the edge roughness is finer than the short-circuit defect and the open-circuit defect, sensitivity between the vertical and horizontal directions of the electric field component of the illumination light is not so large.

Therefore, in the case that the linearly-polarized light is perpendicularly incident to the mask, the polarization direction of the light scattered by the edge roughness becomes a value close to 45 degrees of the polarization direction of the incident light when the linearly-polarized light has the polarization direction of 45 degrees with respect to the direction along the edge of the line and space pattern. However, because the polarization direction is influenced by a base pattern having the periodic repetition, the polarization direction does not completely become 45 degrees, but the polarization direction has the value slightly deviated from 45 degrees.

The short-circuit defect or the open-circuit defect differs from the edge roughness in the influence on the polarization state of the illumination light. Accordingly, even if the pattern has the optical resolution limit or less of the optical system, the defect can be classified by taking advantage of the difference. Specifically, by controlling the polarization state of the illumination light and the condition for the polarization control element in the optical system that images the light reflected from the mask, the bright and dark unevenness caused by the edge roughness can be removed with the polarization control element to extract only the change in amplitude of the short-circuit defect or open-circuit defect.

Referring to FIG. 1, the angle of the half-wavelength plate 1007 is changed such that, in the light incident to the imaging optical system B1 from mask 1005, the light scattered by the edge roughness is prevented from being incident to the sensor 1010. The light scattered by the short-circuit defect or open-circuit defect is separated from the light scattered by the edge roughness, and is incident to the sensor 1010 through the half-wavelength plate 1007. Therefore, in the optical image captured with the sensor 1010, the short-circuit defect and the open-circuit defect are easily inspected, because the short-circuit defect and the open-circuit defect are left while the bright and dark unevenness caused by the edge roughness is removed. That is, the optical image captured with the sensor 1010 can be used to inspect the pattern of the optical resolution limit or less.

The brightness of the light incident to the sensor 1010 is lowered through the polarization beamsplitter 1009. Therefore, because both the gradation values of the white portion and black portion are lowered in the optical image captured with the sensor 1010, the optical image is not suitable for the inspection of the region where the high contrast is required, namely, for the inspection of the pattern of the optical resolution limit or more. At this point, the light incident to the polarization beamsplitter 1009 includes not only the p-polarized light reflected by the mask 1005 but also the s-polarized light, and the s-polarized light is further reflected by the polarization beamsplitter 1009 and is incident to the sensor 1011. That is, with no loss of the brightness through the polarization beamsplitter 1009, the s-polarized light is incident to the sensor 1011 to form the image of the pattern of the mask 1005. Accordingly, the optical image captured with the sensor 1011 has the high contrast between the white and black portions and is suitable for the inspection of the pattern of the optical resolution limit or more. At this point, although the light scattered by the edge roughness is also incident to the sensor 1011, the size (CD) of the pattern and the like are measured in the inspection of the pattern of the optical resolution limit or more. Therefore, whether the short-circuit defect or open-circuit defect and the edge roughness are distinguished from each other is not problematic.

In the configuration in FIG. 1, preferably a light quantity adjustor such as an ND (Neutral Density) filter is provided between the polarization beamsplitter 1009 and the sensor 1011. Therefore, the light incident to the sensor 1011 can be prevented from becoming too bright by adjusting the ratio of quantities of light reflected from the polarization beamsplitter 1009.

In the first embodiment, a quarter-wavelength plate may be arranged in a shared optical path, that is, wherein there is an optical path toward the mask from the light source, and an optical path toward the half-wavelength plate from the mask. For example, in the configuration in FIG. 1, instead of the quarter-wavelength plates 1002 and 1006, the quarter-wavelength plate may be arranged between the half mirror 1003 and the objective lens 1004. The advantageous effect similar to that of the configuration in FIG. 1 can be obtained even in this configuration.

As described above, according to the optical system in FIG. 1, the pattern of the optical resolution limit or less can be inspected using the optical image captured with the sensor 1010. That is, using the optical image, the fine pattern can accurately be inspected without the throughput degradation.

Additionally, according to the optical system in FIG. 1, the pattern of the optical resolution limit or more can be inspected using the optical image captured with the sensor 1011. That is, in the optical system, it is not necessary that the pattern of the optical resolution limit or more and the pattern of the optical resolution limit or less be inspected separately, but the pattern of the optical resolution limit or more and the pattern of the optical resolution limit or less can be inspected within one process.

### Embodiment 2

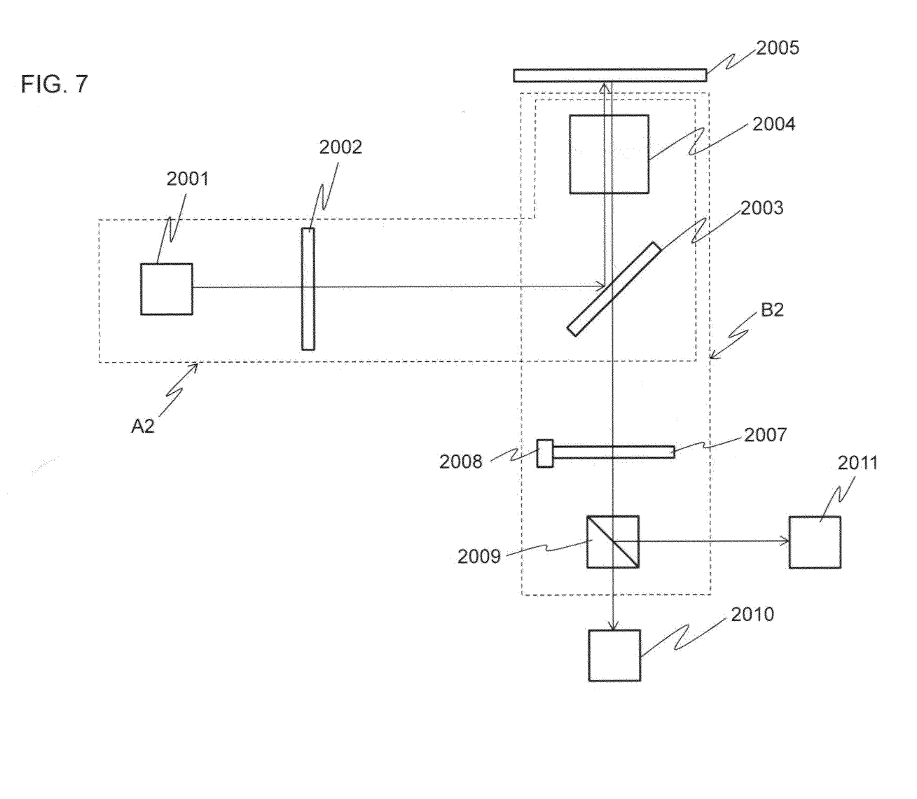

FIG. 7 illustrates an optical system according to a second embodiment. The optical system of the second embodiment also includes an illumination optical system A2 that illuminates a mask 2005 of the inspection target and an imaging optical system B2 that images the light reflected from the mask 2005 on sensors 2010 and 2011. The illumination optical system A2 includes a light source 2001, a half-wavelength plate 2002, a half mirror 2003, and an objective lens 2004. The imaging optical system B2 includes the objective lens 2004, the half mirror 2003, a half-wavelength plate 2007, a rotation mechanism 2008, and a polarization beamsplitter 2009. The half mirror 2003 and the objective lens 2004 are shared by the illumination optical system A2 and the imaging optical system B2.

Many patterns provided in the mask 2005 are repetitive patterns such as the line and space pattern, namely, the regular repetitive pattern having the periodicity. For example, the template in the nanoimprint lithography can also be used as the inspection target instead of the mask 2005. In this case, the repetitive pattern is frequently used in the template.

A laser beam source can be used as the light source 2001. Generally the light emitted from the laser beam source is linearly-polarized light. In the second embodiment, the mask 2005 of the inspection target is inspected while illuminated with the linearly-polarized light. Therefore, the high-resolution optical image is obtained.

In the illumination optical system A2 in FIG. 7, the linearly-polarized light emitted from the light source 2001 is reflected by the half mirror 2003 through the half-wavelength plate 2002, and the linearly-polarized light is transmitted through the objective lens 2004, thereby illuminating the mask 2005. At this point, the angle of the half-wavelength plate 2002 is adjusted such that the periodically repetitive pattern formed in the mask 2005 is illuminated with the linearly-polarized light having the polarization state of 45 degree with respect to the repetitive direction of the pattern. Therefore, the difference between the large defect such as the short-circuit defect and the open-circuit defect and the small defect such as the edge roughness can emerge in regards to the sensitivity for the electric field component of the illumination light, namely, the sensitivity for the vertical and horizontal directions of the electric field component of the illumination light.

When the illumination light has the polarization state of 0 degree or 90 degrees with respect to the repetitive direction of the repetitive pattern formed on the mask 2005, the sensitivity of the illumination light becomes even between the defects, and the large defect and the small defect cannot be distinguished from each other. Accordingly, it is necessary that the polarization state be not 0 degree or 90 degrees with respect to the repetitive direction of the repetitive pattern. However, the polarization state is not necessarily 45 degrees. Specifically, the polarization state is preferably set to the angle except in the ranges of −5 degrees to 5 degrees and 85 degrees to 95 degrees.

The light reflected from the mask 2005 is imaged on the sensors 2010 and 2011 through the imaging optical system B2. At this point, the sensor 2010 corresponds to the first sensor of the present invention, and the sensor 2011 corresponds to the second sensor of the present invention. The first sensor is configured to receive the light as a first optical image, which is transmitted through the polarization beamsplitter 2009. The second sensor is configured to receive the light as a second optical image, which is reflected from the polarization beamsplitter 2009.

Specifically, the light is sequentially transmitted through the objective lens 2004 and the half mirror 2003, and the light is incident to the polarization beamsplitter 2009 after the phase of the light is rotated by the half-wavelength plate 2007. At this point, the quantity of p-polarized light incident to the polarization beamsplitter 2009 and the quantity of s-polarized light are adjusted by changing the angle of the half-wavelength plate 2007. The rotation mechanism 2008 is provided in the half-wavelength plate 2007, and the rotation mechanism 2008 can control the angle of the half-wavelength plate 2007.

The p-polarized light incident to the polarization beamsplitter 2009 is transmitted through the polarization beamsplitter 2009, and is incident to the sensor 2010. The s-polarized light incident to the polarization beamsplitter 2009 is reflected by the polarization beamsplitter 2009, and is incident to the sensor 2011.

The sensors 2010 and 2011 capture the same image of the mask 2005. The image, that is, the first optical image, captured with the sensor 2010 is used to inspect the pattern of the optical resolution limit or less. On the other hand, the image, that is, the second optical image captured with the sensor 2011 is used to inspect the pattern of the optical resolution limit or more.

The image captured with the sensor 2010 will be described below.

As illustrated in FIG. 7, only the light in the specific polarization direction can be extracted by arranging the half-wavelength plate 2007 in the imaging optical system B2. Specifically, the angle of the half-wavelength plate 2007 is changed such that, in the light incident to the imaging optical system B2 from mask 2005, the light scattered by the edge roughness is prevented from being incident to the sensor 2010. The light scattered by the short-circuit defect or open-circuit defect is separated from the light scattered by the edge roughness, and is incident to the sensor 2010 through the half-wavelength plate 2007. Therefore, in the optical image captured with the sensor 2010, the short-circuit defect and the open-circuit defect are easily inspected, because the short-circuit defect and the open-circuit defect are left while the bright and dark unevenness caused by the edge roughness is removed. That is, the optical image captured with the sensor 2010 can be used to inspect the pattern of the optical resolution limit or less.

As described above, the light incident to the sensor 2010 through the polarization beamsplitter 2009 is the p-polarized light reflected from the mask 2005, and the s-polarized light reflected from the mask 2005 is further reflected by the polarization beamsplitter 2009 and is incident to the sensor 2011. At this point, the brightness of the p-polarized light is lowered through the polarization beamsplitter 2009. That is, with no loss of the brightness through the polarization beamsplitter 1009, the s-polarized light is incident to the sensor 1011 to form the image of the pattern of the mask 1005. Accordingly, the optical image captured with the sensor 1011 has the high contrast between the white and black portions and is suitable for the inspection of the pattern of the optical resolution limit or more.

At this point, although the light scattered by the edge roughness is also incident to the sensor 2011, the size (CD) of the pattern and the like are measured in the inspection of the pattern of the optical resolution limit or more. Therefore, whether the short-circuit defect or open-circuit defect and the edge roughness are distinguished from each other is not problematic.

In the configuration in FIG. 7, preferably a light quantity adjustor such as an ND (Neutral Density) filter is provided between the polarization beamsplitter 2009 and the sensor 2011. Therefore, the light incident to the sensor 1011 can be prevented from becoming too bright by adjusting a ratio of quantities of light reflected from the polarization beamsplitter 2009.

As described above, according to the optical system in FIG. 7, the pattern of the optical resolution limit or less can be inspected using the optical image captured with the sensor 2010. That is, using the optical image, the fine pattern can accurately be inspected without the throughput degradation.

Additionally, the pattern of the optical resolution limit or more can be inspected using the optical image captured with the sensor 2011. That is, in the optical system, it is not necessary that the pattern of the optical resolution limit or more and the pattern of the optical resolution limit or less be inspected separately, but the pattern of the optical resolution limit or more and the pattern of the optical resolution limit or less can be inspected within one process.

Additionally, in the optical system in FIG. 7, the mask 2005 is illuminated with the linearly-polarized light, and the light reflected from the mask 2005 is the linearly-polarized light. Therefore, it is not necessary to provide the quarter-wavelength plate in the imaging optical system B2.

### Embodiment 3

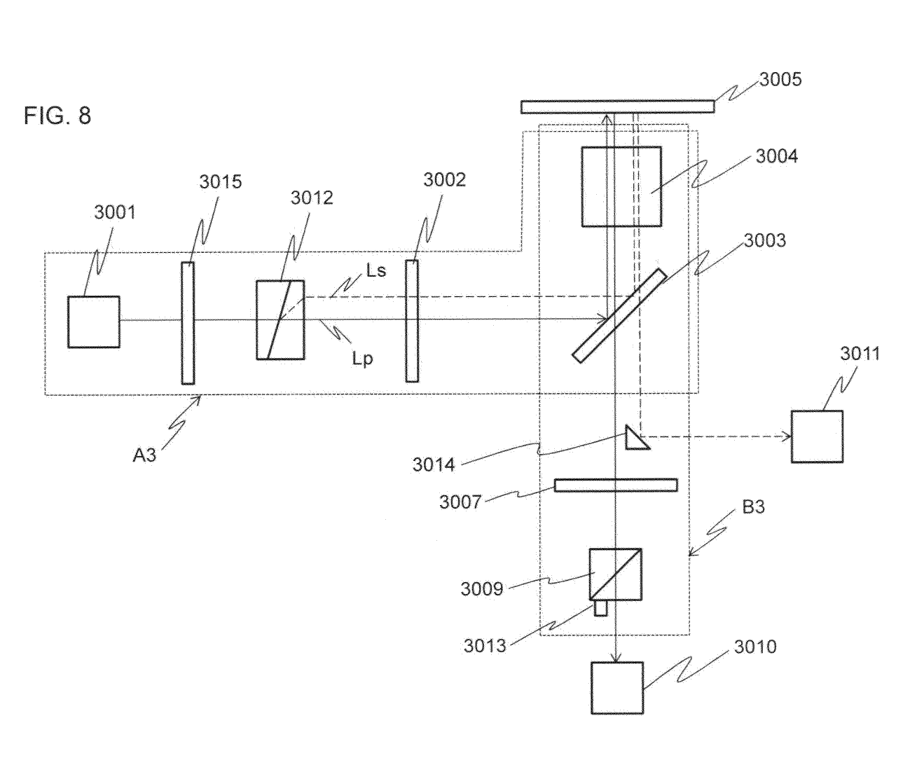

FIG. 8 illustrates an example of an optical system according to a third embodiment. The optical system of the third embodiment also includes an illumination optical system A4 that illuminates a mask 3005 of the inspection target and an imaging optical system B3 that images the light reflected from the mask 3005 on the sensors 3010 and 3011.

The illumination optical system A3 includes a light source 3001, a half-wavelength plate 3015, a Rochon prism 3012 as a branching element, a quarter-wavelength plate 3002, a half mirror 3003, and an objective lens 3004. The imaging optical system B3 includes the objective lens 3004, the half mirror 3003, a quarter-wavelength plate 3007, a polarization beamsplitter 3009 including a rotation mechanism 3013, and a mirror 3014. The half mirror 3003 and the objective lens 3004 are shared by the illumination optical system A3 and the imaging optical system B3.

Many patterns provided in the mask 3005 are repetitive patterns such as the line and space pattern, namely, the regular repetitive pattern having the periodicity. For example, the template in the nanoimprint lithography can also be used as the inspection target instead of the mask 3005. In this case, the repetitive pattern is frequently used in the template.

In an illumination optical system A3, a laser beam source can be used as the light source 3001 as shown in FIG. 1. Generally the light emitted from the laser beam source is the linearly-polarized light. The linearly-polarized light emitted from the light source 3001 is incident to the Rochon prism 3012, that is, of the branching element after the phase of the linearly-polarized light is rotated by 90 degrees with the half-wavelength plate 3015. At this point, the quantity of p-polarized light (Lp) incident to the Rochon prism 3012 and the quantity of s-polarized light (Ls) can be adjusted by the angle of the half-wavelength plate 3015.

Although the Rochon prism 3012 transmits the p-polarized light component (Lp) straight, the Rochon prism 3012 transmits the s-polarized light component (Ls) while displacing the s-polarized light component from the original optical axis. Any other branching element that can branch the polarized light components, orthogonal to each other, into two separate lights, may be used instead of the Rochon prism 3012 or another polarizing prism.

The light transmitted through the Rochon prism 3012 is incident to a quarter-wavelength plate 3002. The quarter-wavelength plate 3002 changes the linearly-polarized light to the circularly-polarized light. After the p-polarized light (Lp) and the s-polarized light (Ls) are reflected by a half mirror 3003, a mask 3005 that becomes the inspection target is illuminated with the p-polarized light and the s-polarized light through an objective lens 3004. In this case, because the mask 3005 is illuminated with the circularly-polarized light, the optical image is obtained with the directionless resolution characteristic.

The light reflected from the mask 3005 is imaged on the sensors 3010 and 3011 by the imaging optical system 83. At this point, the p-polarized light (Lp) is incident to the sensor 3010 and the s-polarized light (Ls) is incident to the sensor 3011. The sensor 3010 corresponds to the first sensor of the present invention, and the sensor 3011 corresponds to the second sensor of the present invention. The first sensor is configured to receive the light as a first optical image, which is transmitted through the polarization beamsplitter 3009. The second sensor is configured to receive the light as a second optical image, which is reflected from the polarization beamsplitter 3009.

The p-polarized light (Lp) differs from the s-polarized light (Ls) in an optical axis, so that the sensors 3010 and 3011 can capture the different images of the mask 3005. The image, that is, the first optical image captured with the sensor 3010 is used to inspect the pattern of the optical resolution limit or less, and the image, that is, the second optical image captured with the sensor 3011 is used to inspect the pattern of the optical resolution limit or more.

The p-polarized light (Lp) reflected from the mask 3005 is sequentially transmitted through the objective lens 3004 and the half mirror 3003, and changes into the linearly-polarized light through the quarter-wavelength plate 3007. Then the p-polarized light (Lp) is incident to the polarization beamsplitter 3009. The rotation mechanism 3013 is provided in the polarization beamsplitter 3009, and the rotation mechanism 3013 can adjust the angle of the polarization beamsplitter 3009.

The polarization beamsplitter 3009 can be rotated to transmit only the light having the specific polarization direction through the polarization beamsplitter 3009. The angle of the polarization beamsplitter 3009 is changed such that, in the light incident to the imaging optical system B3 from mask 3005, the light scattered by the edge roughness is prevented from being incident to the sensor 3010. The light scattered by the short-circuit defect or open-circuit defect is separated from the light scattered by the edge roughness, and is incident to the sensor 3010 through the polarization beamsplitter 3009. Therefore, in the optical image captured with the sensor 3010, the short-circuit defect and the open-circuit defect are easily inspected, because the short-circuit defect and the open-circuit defect are left while the bright and dark unevenness caused by the edge roughness is removed. That is, the optical image captured with the sensor 3010 can be used to inspect the pattern of the optical resolution limit or less.

On the other hand, the s-polarized light (Ls) reflected from the mask 3005 is displaced to the optical axis different from that of the p-polarized light (Lp) by the Rochon prism 3012, reflected by the mirror 3014 arranged on the optical axis of the s-polarized light (Ls), and is incident to the sensor 3011 with the optical path changed.

As described above, the light incident to the sensor 3010 is the p-polarized light reflected from the mask 3005, and the brightness of the light is lowered through the polarization beamsplitter 3009. That is, with no loss of the brightness through the polarization beamsplitter 3009, the s-polarized light is incident to the sensor 3011 to form the image of the pattern of the mask 3005. Accordingly, the optical image captured with the sensor 3011 has the high contrast between the white and black portions of the optical image and is suitable for the inspection of the pattern of the optical resolution limit or more.

At this point, although the light scattered by the edge roughness is also incident to the sensor 3011, the size (CD) of the pattern and the like are measured in the inspection of the pattern of the optical resolution limit or more. Therefore, whether the short-circuit defect or open-circuit defect and the edge roughness are distinguished from each other is not problematic.

Thus, according to the configuration in FIG. 8, the Rochon prism 3012 branches the light emitted from the light source 3001. Because the quantities of branched p-polarized light (Lp) and s-polarized light (Ls) can be adjusted by the Rochon prism 3012, it is not necessary to provide the light quantity adjustor such as the ND (Neutral Density) filter on the optical path of the s-polarized light (Ls).

The optical image captured with the sensor 3010 is used to inspect the pattern of the optical resolution limit or less, and the fine pattern can accurately be inspected using the optical image without the throughput degradation.

Additionally, the pattern of the optical resolution limit or more can be inspected using the optical image captured with the sensor 3011. That is, in the optical system, it is not necessary that the pattern of the optical resolution limit or more and the pattern of the optical resolution limit or less be inspected separately, but the pattern of the optical resolution limit or more and the pattern of the optical resolution limit or less can be inspected within one process.

In FIG. 8, the polarization beamsplitter 3009 may be configured so as not to be rotatable. In this case, the half-wavelength plate is arranged between the quarter-wavelength plate 3007 and the polarization beamsplitter 3009. The angle of the half-wavelength plate is changed such that, in the light incident to the imaging optical system B3 from the mask 3005, the light scattered by the edge roughness is prevented from being incident to the sensor 3010.

In the third embodiment, the quarter-wavelength plate may be arranged on the optical path shared by the optical path toward the mask from the branching element and the optical path toward the polarization beamsplitter from the mask. For example, in the configuration in FIG. 8, instead of the quarter-wavelength plates 3002 and 3007, the quarter-wavelength plate may be arranged between the half mirror 3003 and the objective lens 3004. The advantageous effect similar to that of the configuration in FIG. 8 can be obtained even in this configuration.

### Embodiment 4

In an inspection apparatus according to a fourth embodiment, one of a die-to-database comparison method and a die-to-die comparison method may be used to inspect the pattern of the optical resolution limit or more. The die-to-database comparison method will be described below by way of example. In the die-to-database comparison method, a reference image produced from design data for the pattern of the inspection target becomes a reference image, namely, an image that is compared to the optical image of the pattern in order to detect the defect. On the other hand, a method for comparing an interesting pixel in one image to a pixel around the interesting pixel is used to inspect the pattern of the optical resolution limit or less. On the other hand, in the die-to-die comparison method, an image captured by photographing the same pattern as the pattern captured with the second sensor pattern, becomes a reference image.

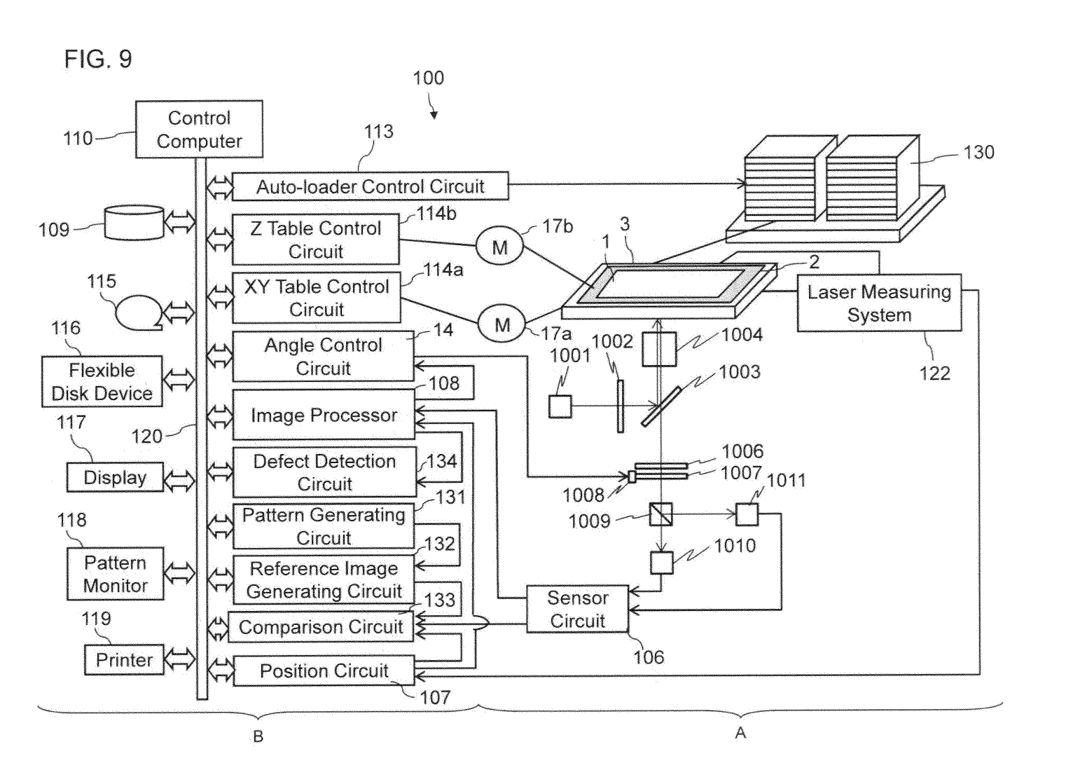

FIG. 9 is a configuration diagram illustrating an inspection apparatus 100 of the fourth embodiment. The inspection apparatus 100 includes the optical system in FIG. 1, and has the configuration in which an angle control circuit 14 controls the angle of the half-wavelength plate 1007. In FIG. 9, the same component as that in FIG. 1 is designated by the same numeral. Further the angle control circuit 14 corresponds to an angle adjusting unit according to the present invention.

The inspection apparatus 100 includes an optical image acquisition unit A and a control unit B as shown in FIG. 9.

The optical image acquisition unit A includes the optical unit as shown in FIG. 1. Further, it includes an XY-table 3 that is movable in a horizontal direction (an X direction and a Y direction), a sensor circuit 106, a laser measuring system 122, and an auto- loader 130. The XY-table 3 may have a structure movable in a rotational direction.

A sample 1 that is the inspection target is placed on a Z-table 2. The Z-table 2 is provided on the XY-table 3, and is horizontally movable together with the XY-table 3. Examples of the sample 1 include a mask used in the photolithography and a template used in the nanoimprint technology.

Patterns provided in the sample 1 are repetitive patterns such as the line and space pattern, namely, the regular repetitive pattern having the periodicity. The pattern formed in the sample 1 does not have the constant density, that is, the pattern of the optical resolution limit or less, and the pattern of the optical resolution limit or more exist in the sample 1. The pattern formed in the memory mat of the semiconductor chip can be cited as an example of the pattern of the optical resolution limit or less. On the other hand, the pattern formed in the peripheral circuit can be cited as an example of the pattern of the optical resolution limit or more. As used herein, the optical resolution limit means a resolution limit of the optical system in the inspection apparatus 100, namely, the resolution limit (R=λ/2NA) defined by the wavelength (λ) of the light emitted from the light source 1001 and the numerical aperture (NA) of the objective lens 1004.

Preferably the sample 1 is supported at three points using support members provided in the Z-table 2. In the case that the sample 1 is supported at four points, it is necessary to adjust a height of the support member with high accuracy. Unless the height of the support member is sufficiently adjusted, there is a risk of deforming the sample 1. On the other hand, in the three-point support, the sample 1 can be supported while the deformation of the sample 1 is suppressed to the minimum. The supporting member is configured by using a ballpoint having a spherical head surface. For example, two support members of the three support members are in contact with the sample 1 at two corners, which are not diagonal but adjacent to each other in four corners of the sample 1. The remaining support member in the three support members is disposed in the region between the two corners at which the two other support members are not disposed.

The light source 2001 emits the light to the sample 1 in order to acquire the optical image of the sample 1. A light source that emits the DUV (Deep Ultraviolet Radiation) light is preferably used as the light source 1001. The use of the DUV light can relatively easily construct the optical system, and inspect the fine pattern with the higher throughput compared with the use of the EB (Electron Beam).

The linearly-polarized light emitted from the light source 1001 changes into the circularly-polarized light through the quarter-wavelength plate 1002. Then, the light is reflected by the half mirror 1003 and transmitted through the objective lens 1004, thereby illuminating the sample 1 with the light.

The light reflected from the sample 1 is sequentially transmitted through the objective lens 1004 and the half mirror 1003, and the light is changed into the linearly-polarized light by the quarter-wavelength plate 1006 again. Then the light is incident to the polarization beamsplitter 1009 after a polarization direction of the light is changed by the half-wavelength plate 1007. The rotation mechanism 1008 is provided in the half-wavelength plate 1007, and the rotation mechanism 1008 can control the angle of the half-wavelength plate 1007.

The p-polarized light incident to the polarization beamsplitter 1009 is transmitted through the polarization beamsplitter 1009, and is incident to the sensor 1010. On the other hand, the s-polarized light incident to the polarization beamsplitter 1009 is reflected by the polarization beamsplitter 1009, and is incident to the sensor 1011.

At this point, the angle of the half-wavelength plate 1007 is set such that, in the light from sample 1, the light scattered by the edge roughness is prevented from being incident to the sensor 1010. Therefore, the light scattered by the short-circuit defect or open-circuit defect is separated from the light scattered by the edge roughness, and is incident to the sensor 1010 through the half-wavelength plate 1007.

The light incident to the polarization beamsplitter 1009 includes not only the p-polarized light reflected from the sample 1 but also the s-polarized light, and the s-polarized light is further reflected by the polarization beamsplitter 1009 and is incident to the sensor 1011.

Preferably the inspection apparatus 100 includes the light quantity adjustor such as the ND (Neutral Density) filter between the polarization beamsplitter 1009 and the sensor 1011. Therefore, the light incident to the sensor 1011 can be prevented from becoming too bright by adjusting a ratio of quantities of light reflected from the polarization beamsplitter 1009.

Next, the control unit B as shown in Fig. 9 will be described.

In the control unit B, a control computer 110 that controls the whole inspection apparatus 100 is connected to a position circuit 107, a image processor 108, the angle control circuit 14, an pattern generating circuit 131, a reference image generating circuit 132, a comparison circuit 13 as a comparator, a defect detection circuit 134 as a defect detector, an auto-loader control circuit 113, a XY- table control circuit 114a, Z-table control circuit 114b, a magnetic disk device 109, a magnetic tape device 115, and flexible disk device 116, which are examples of a storage device, a display 117, a pattern monitor 118, and a printer 119 through a bus 120 that constitutes a data transmission line.

In FIG. 9, the “circuit” maybe constructed with an electric circuit or a program running on a computer. The circuit may also be implemented by not only the program of software but also a combination of hardware and software or a combination of software and firmware. In the case that the circuit is constructed with the program, the program can be recorded in the magnetic disk device 109. For example, each circuit in FIG. 9 may be constructed with the electric circuit or the software that can be processed by the control computer 110. Each circuit in FIG. 9 may be constructed with the combination of the electric circuit and the software. As a more specific example, the defect detection circuit 134, as a detector, may be an apparatus construction, or may be implemented as a software program, or may be implemented as a combination of software and firmware, or software and hardware.

The Z-table 2 is driven by the motor 17b controlled by the Z- table control circuit 114b. The XY-table 3 is driven by the motor 17a controlled by the XY-table control circuit 114a. For example, a stepping motor is used as each motor.

In the optical image acquisition unit A in FIG. 9, the optical image of the sample 1 is captured with the sensors 1010 and 1011. An example of a specific method for acquiring the optical image will be described below.

The sample 1 is placed on the Z- table 2 that is movable in the perpendicular direction. The Z-table 2 is also movable in the horizontal direction by the XY-table 3. A moving position of the XY-table 3 is measured by the laser length measuring system 122, and sent to the position circuit 107. The sample 1 on the XY-table 3 is automatically conveyed from the autoloader 130 that is driven by the auto-loader control circuit 113, and the sample 1 is automatically discharged after the inspection is ended.

The light source 1001 emits the light with which the sample 1 is illuminated. The linearly-polarized light emitted from the light source 1001 changes into the circularly-polarized light through the quarter-wavelength plate 1002, and the light is reflected by the half mirror 1003, and focused on the sample 1 by the objective lens 1004. A distance between the objective lens 1004 and the sample 1 is adjusted by moving the Z-table 2 in the perpendicular direction.

The light reflected from the sample 1 is transmitted through the objective lens 1004 and the half mirror 1003, and the light changes into the linearly-polarized light through the quarter-wavelength plate 1006. Then the light is transmitted through the half-wavelength plate 1007. At this point, the polarization direction of the light is rotated.

Then the light is incident to the sensor 1010 through the polarization beamsplitter 1009. On the other hand, the light reflected by the polarization beamsplitter 1009 is incident to the sensor 1011. The sensor 1010 receives the light as a first optical image, and the sensor 1011 receives the light as a second optical image.

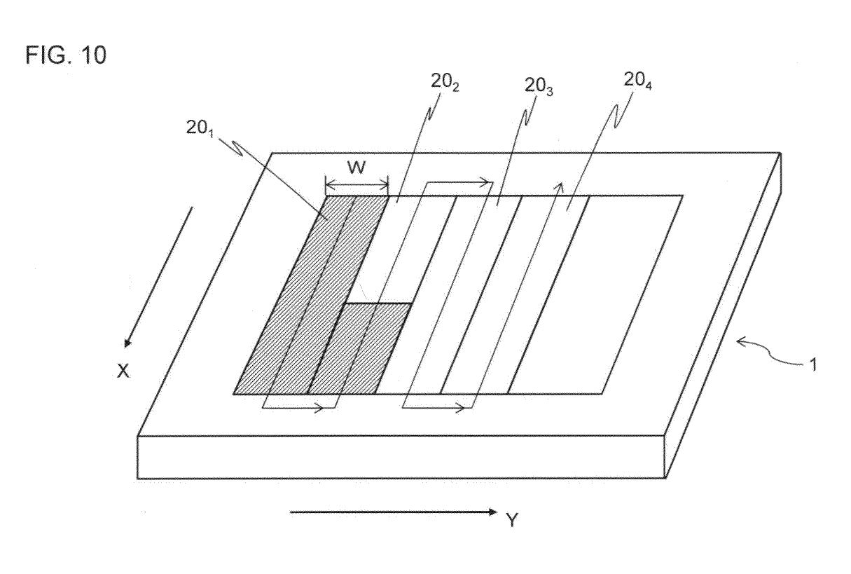

FIG. 10 is a view illustrating a procedure to acquire the optical image of the pattern formed in the sample 1.

As illustrated in FIG. 10, an inspection region on the sample 1 is virtually divided into plural strip-like frames 20₁, 20₂, 20₃, 20₄, . . . . The XY-table control circuit 114a controls motion of the XY-table 3 in FIG. 9 such that the frames 20₁, 20₂, 20₃, 20₄, . . . are continuously scanned. Specifically, the images having a scan width W in FIG. 10 are continuously input to each of the sensors 1010 and 1011 while the XY-table 3 moves in the −X-direction.

That is, after the image of the first frame 20₁ is captured, the image of the second frame 20₂ is captured. In this case, the optical image is captured while the XY-table 3 moves in the opposite direction (X-direction) to the direction in which the image of the first frame 20₁ is captured, and the images having the scan width W are continuously input to the sensors (1010 and 1011). In the case that the image of the third frame 20₃ is captured, the XY-table 3 moves in the opposite direction (-X-direction) to the direction in which the image of the second frame 20₂ is captured, namely, the direction in which the image of the first frame 20₁ is captured. A hatched-line portion in FIG. 10 schematically expresses the region where the optical image is already captured in the above way.

After the pattern images formed in the sensors 1010 and 1011 are subjected to photoelectric conversion, the sensor circuit 106 performs A/D (Analog to Digital) conversion to the pattern images. For example, a line sensor in which CCD cameras that are of the image capturing elements are arrayed in line is used as the sensors (1010 and 1011). A TDI (Time Delay Integration) sensor can be cited as an example of the line sensor. In this case, the image of the pattern in the sample 1 is captured by the TDI sensor while the XY-table 3 continuously moves in the X-axis direction.

The optical image data, to which the sensor circuit 106 performs the A/D conversion after the image capturing with the sensor 1010, is sent to the image processor 108. In the image processor 108, the optical image data is expressed by the gradation value of each pixel. For example, one of values of a 0 gradation value to a 255 gradation value is provided to each pixel using a gray scale having 256-level gradation value.

The optical image data sent to the image processor 108 from the sensor 1010 through the sensor circuit 106 is used to inspect the pattern of the optical resolution limit or less in the sample 1. Particularly, in order that the light scattered by the edge roughness in the light from the sample 1 is prevented from being incident to the sensor 1010, by setting an angle θ of the half-wavelength plate 1007, the light scattered by the short-circuit defect or open-circuit defect is incident to the sensor 1010 through the half-wavelength plate 1007 while separated from the light scattered by the edge roughness. Therefore, in the optical image captured with sensor 1010, the short-circuit defect and the open-circuit defect are left while the bright and dark unevenness caused by the edge roughness is removed. Accordingly, the use of the optical image can inspect the short-circuit defect and the open-circuit defect, namely, the pattern of the optical resolution limit or less.

A specific method for finding the condition that removes the bright and dark unevenness caused by the edge roughness will be described below.

Generally the many pieces of edge roughness exist in the whole surface of the mask or template of the inspection target while very few number of short-circuit defects or open-circuit defects exist in the mask or template. For example, when the optical image having the region of 100 μm×100 μm is acquired, there is a low possibility that the short-circuit defect or the open-circuit defect is included in the region, and the very few defects exist in the region even if the short-circuit defect or the open-circuit defect is included in the region. That is, almost all the optical images in the region are caused by the edge roughness. This means that the condition that removes the defect caused by the edge roughness is obtained from one optical image having the size of about 100 μm×about 100 μm.

The change in gradation value caused by the edge roughness in the optical image can be removed by controlling the polarization direction of the light incident to the sensor 1010 on the imaging optical system side. Specifically, the quantity of light that is incident to the sensor 1010, while being scattered by the edge roughness, is changed by controlling the angle of the half-wavelength plate 1007, which allows the bright and dark amplitude to be changed in the optical image.

The bright and dark amplitude in the optical image can be expressed by a standard deviation of the gradation value in each pixel. For example, assuming that the optical system (described in FIG. 1) has a pixel resolution of 50 nm in the inspection apparatus 100 in FIG. 9, the optical image having the region of 100 μm×100 μm is expressed by 4 million pixels. That is, a specimen of 4 million gradation values is obtained from the one optical image.

For a dark-field illumination system, the standard deviation is obtained with respect to the specimen, the obtained standard deviation is defined as an extent of the scattering light caused by the edge roughness, and the polarization state on the imaging optical system side, namely, the angle of the half-wavelength plate 1007 is adjusted such that the standard deviation becomes the minimum. Therefore, the quantity of scattering light incident to the sensor 1010 due to the edge roughness can be minimized.

For the optical image in a bright-field optical system, an extent of the brightness and darkness caused by the edge roughness is influenced by zero-order light. The reason is as follows. Because the fine periodic pattern of the optical resolution limit or less exists in the inspection target, the polarization state of the zero-order light changes due to a phase-difference effect caused by structural birefringence. Therefore, the light quantity that becomes a base also changes when the half-wavelength plate is rotated in order to remove the reflected light caused by the edge roughness. Because the bright-field image is a product of an electric field amplitude of the scattering light from the short-circuit defect, the open-circuit defect, or the edge roughness and an electric field amplitude of the zero-order light, the extent of the brightness and darkness caused by the edge roughness is influenced by an intensity of the zero-order light.

In order to remove the influence of the scattering light due to the edge roughness to improve the detection sensitivity for the short-circuit defect or open-circuit defect, it is necessary to find, not the condition in which a function (specifically, a function expressing the electric field amplitude of the zero-order light) caused by the zero-order light becomes the minimum, but the condition that a function (specifically, a function expressing the electric field amplitude of the scattering light caused by the edge roughness) caused by the edge roughness becomes the minimum. The reason the function caused by the zero-order light becomes the minimum is that the function caused by the zero-order light is the condition that the base light quantity simply becomes the minimum but the influence of the edge roughness is not completely removed.

The function caused by the edge roughness becomes the minimum is obtained by a calculation using a standard deviation σ of the gradation value of the optical image and an average gradation value A. The standard deviation σ includes various noise factors, and particularly the standard deviation σ is largely influenced by the brightness and darkness caused by the edge roughness. The average gradation value A of the optical image is the base light quantity, namely, the intensity of the zero-order light. The electric field amplitude of the scattering light due to the edge roughness is proportional to a value in which the standard deviation σ of the optical image is divided by a square root of the average gradation value A. In order to find the condition that minimizes the bright and dark amplitude caused by the edge roughness, the optical image is acquired while the angle θ of the half-wavelength plate 1007 is changed, and the value in which the standard deviation of the gradation value in the obtained optical image is divided by the square root of the average gradation value is calculated. The angle θ is obtained when the value becomes the minimum.

As described in the first embodiment, for the large defect such as the short-circuit defect and the open-circuit defect, the vertical direction and the horizontal direction differ from each other in the sensitivity for the electric field component of the illumination light. Accordingly, when the electric field amplitude of the scattering light caused by the large defect becomes the minimum, the angle θ of the half-wavelength plate 1007 differs from that of the scattering light caused by the edge roughness. That is, even if the angle θ is applied when the electric field amplitude of the scattering light caused by the edge roughness becomes the minimum, the electric field amplitude of the scattering light caused by the short-circuit defect or the open-circuit defect does not become the minimum. Therefore, the short-circuit defect and the open-circuit defect can be detected without being buried in the amplitude of the brightness and darkness caused by the edge roughness.

When the electric field amplitude of the scattering light caused by the edge roughness becomes the minimum, the angle θ depends on a structure of the pattern formed in the inspection target. For example, the angle θ at which the electric field amplitude becomes the minimum also changes when a pitch, a depth, or a line and space ratio of the pattern changes. Accordingly, it is necessary to obtain the angle θ according to the structure of the pattern of the inspection target. In the case that the identical pattern is provided in the inspection target, the previously-obtained angle θ can continuously be used in an inspection process. On the other hand, in the case that plural patterns having different structures are provided in the inspection target, it is necessary to change the angle θ according to the pattern. Additionally, even in the identical design pattern, the depth or the line and space ratio is slightly changed by various error factors, and possibly the angle θ of the half-wavelength plate 1007, which minimizes the electric field amplitude of the scattering light, has a variation on the sample 1. Therefore, it is necessary to follow the variation to change the angle θ of the half-wavelength plate 1007.

Thus, the condition that removes the bright and dark unevenness caused by the edge roughness, namely, the angle of the half-wavelength plate 1007 can be obtained. This processing is performed at a stage prior to the inspection of the sample 1. Specifically, in order to find the condition that removes the defect caused by the edge roughness, the sensor 1010 captures the optical image of the sample 1 while the angle of the half-wavelength plate 1007 is changed. As described above, for example, one optical image having the size of about 100 μm×about 100 μm may be obtained at each predetermined angle of the half-wavelength plate 1007. The obtained optical image data is sent to the image processor 108 through the sensor circuit 106.

As described above, the optical image data is expressed by the gradation value of each pixel in the image processor 108. Therefore, in the dark-field illumination system, the standard deviation is obtained with respect to one optical image, the obtained standard deviation is defined as the extent of the scattering light caused by the edge roughness, and the angle of the half-wavelength plate 1007 is obtained such that the standard deviation becomes the minimum. On the other hand, in the bright-field illumination system, the image processor 108 obtains the standard deviation σ and the average gradation value A of the gradation value. The optical image is acquired while the angle θ of the half-wavelength plate 1007 is changed, the value in which the standard deviation σ of the gradation value in the acquired optical image is divided by the square root of the average gradation value A is calculated, and the angle of the half-wavelength plate 1007 is obtained when the value becomes the minimum.

The information on the angle of the half-wavelength plate 1007 obtained by the image processor 108 is sent to the angle control circuit 14. The angle control circuit 14 controls the rotation mechanism 1008 of the half-wavelength plate 1007 according to the information from the image processor 108. Therefore, because the light scattered by the edge roughness is prevented from being incident to the sensor 1010, the light scattered by the short-circuit defect or the open-circuit defect is transmitted through the half-wavelength plate 1007 while separated from the light scattered by the edge roughness, and the light scattered by the short-circuit defect or the open-circuit defect is incident to the sensor 1010. In the optical image captured by the sensor 1010, the short-circuit defect or the open-circuit defect is left while the bright and dark unevenness caused by the edge roughness is removed. Accordingly, the use of the optical image can inspect the short-circuit defect or the open-circuit defect, namely, the pattern of the optical resolution limit or less.

In the image processor 108, the image data in the optical image (in which the defect caused by the edge roughness is removed) is expressed by the gradation value of each pixel. The inspection region of the sample 1 is divided into the predetermined unit regions, and the average gradation value is obtained in each unit region. For example, the predetermined unit region can be set to the region of 1 mm×1 mm. The information on the gradation value obtained by the image processor 108 is sent to the defect detection circuit 134. When the short-circuit defect or the open-circuit defect exists in the repetitive pattern of the optical resolution limit or less of the optical system, an irregularity is generated in the regularity of the pattern, the gradation value in the location where the defect exists varies from the surrounding gradation value. Therefore, the short-circuit defect or the open-circuit defect can be detected. Specifically, for example, the defect detection circuit 134 has thresholds above and below the average gradation value, and the location is recognized as the defect when the gradation value sent from the image processor 108 exceeds the threshold. The threshold level is set in advance of the inspection.

After the pattern image formed on the sensor 1011 is subjected to the photoelectric conversion, the sensor circuit 106 performs the A/D (Analog to Digital) conversion to the pattern image. Then the pattern image data is sent to the comparison circuit 133. The data indicating the position of the sample 1 on the XY-table 3 is output from the position circuit 107, and sent to the comparison circuit 133. The reference image generation circuit 132 sends the image that becomes a criterion for defects of the optical image captured with the sensor 1011, namely, the reference image to the comparison circuit 133.

A method for generating the reference image will be described below.

The design pattern data that is reference data of the die-to-database method is stored in the magnetic disk drive 109.

CAD data 201 produced by a designer (user) is converted into design intermediate data 202 having a hierarchical format such as OASIS. The design pattern data, which is produced in each layer and formed in the mask, is stored in the design intermediate data 202. At this point, generally the inspection apparatus is configured not to directly read OASIS data. That is, independent format data is used by each manufacturer of an inspection apparatus. For this reason, the OASIS data is input to the inspection apparatus 100 after conversion into format data 203 unique to the inspection apparatus in each layer. In this case, the format data 203 can be set to a data format that is unique to the inspection apparatus 100 or to the data format that is compatible with a drawing apparatus, which draws a pattern on a sample.

The format data is input to the magnetic disk drive 109 in FIG. 9. That is, the design pattern data used during the formation of the pattern in the mask 101 is stored in the magnetic disk drive 109.

The figure patterns included in the design pattern, may be a rectangle or a triangle used as a basic graphic pattern. For example, Graphic data in which the shape, size, and position of each graphic pattern is stored in the magnetic disk drive 109. For example, the graphic data is information such as a coordinate (x, y) from the original position of the graphic pattern, a side length, and a graphic code that is an identifier identifying a graphic pattern type such as a rectangle and a triangle.

A set of graphic patterns existing within a range of several tens of micrometers is generally called a cluster or a cell, and the data is layered using the cluster or cell. In the cluster or cell, a disposition coordinate and a repetitive amount are defined in the case that various graphic patterns are separately disposed or repetitively disposed with a certain distance. The cluster or cell data is disposed in a strip-shaped region called a stripe. The strip-shaped region has a width of several hundred micrometers and a length of about 100 mm that corresponds to a total length in an X-direction or a Y-direction of the sample 1.

The pattern generating circuit 131 reads the input design pattern data from the magnetic disk drive 109 through the control computer 110.

In the pattern generating circuit 131, the design pattern data is converted into image data (bit pattern data). That is, the pattern generating circuit 131 extracts the design pattern data to individual data of each graphic pattern, and interprets the figure pattern code and figure pattern dimension, which indicate the figure pattern shape of the design pattern data. The design pattern data is extracted to binary or multi-value image data as the pattern disposed in a square having a unit of a grid of a predetermined quantization dimension. Then an occupancy rate of the graphic pattern in the design pattern is calculated in each region (square) corresponding to a sensor pixel, and the occupancy rate of the graphic pattern in each pixel becomes a pixel value.

The image data converted by the pattern generating circuit 131 is transmitted to the reference image generating circuit 132 to produce a reference image (also referred to as reference data).

The reference image generation circuit 132 performs proper filtering to the design pattern data that is of the graphic image data. The reason is as follows.

In the production process because roundness of the corner and a finished dimension of the line width is adjusted, the pattern in the sample 1 is not strictly matched with the design pattern. The optical image data 204, that is, the optical image obtained from the sensor circuit 106 in FIG. 9 is faint due to a resolution characteristic of the optical system or an aperture effect of the sensors, in other words, the state in which a spatial lowpass filter functions. Therefore, the sample 1 that is the inspection target is observed in advance of the inspection, a filter coefficient imitating the production process or a change of an optical system of the inspection apparatus 100 is determined to subject the design pattern data to a two-dimensional digital filter. Thus, the processing of imitating the optical image is performed to the reference image.

The learning process of the filter coefficient may be performed using the pattern of the mask or template that is the reference fixed in the production process or a part of the pattern of the sample 1 that is the inspection target. In the latter case, the filter coefficient is acquired in consideration of the pattern line width of the region used in the learning process or a finished degree of the roundness of the corner, and reflected in a defect determination criterion of the whole sample 1.

In the case that the sample 1 that is the inspection target is used, advantageously the learning process of the filter coefficient can be performed without removing influences such as a variation of production lot and a fluctuation in condition of the inspection apparatus 100. However, when the dimension fluctuates in the surface of the sample 1, the filter coefficient becomes optimum with respect to the position used in the learning process, but the filter coefficient does not necessarily become optimum with respect to other positions, which results in a pseudo defect. Therefore, preferably the learning process is performed around the center of surface of the mask that is hardly influenced by the fluctuation in dimension. Alternatively, the learning process is performed at multiple positions in the surface of the sample 1, and the average value of the obtained multiple filter coefficients may be used.

The reference image generated by the reference image generation circuit 132 is sent to the comparison circuit 133. The comparison circuit 133 compares the reference image and the optical image captured by the sensor 1011 to each other by the die-to-database comparison method. Specifically, the captured stripe data is cut out in units of inspection frames, and compared to the data that becomes the standard of the criterion for defects in each inspection frame using a proper comparison and determination algorithm.

As a result of the comparison, the location is determined to be defective when a difference between the optical image data and the reference data, that is, at least one difference of position and shape between the optical image and the reference image, exceeds the predetermined threshold. The information on the defect is stored as a mask inspection result. For example, the control computer 110 stores a coordinate of the defect and the optical image that becomes a base of the criterion for defects in the magnetic disk device 109 as the mask inspection result.

More specifically, the defect determination can be made by the following two kinds of methods. One is a method for determining that the optical image is defective when a difference between the position of a contour in the reference image and the position of a contour in the optical image exceeds a predetermined threshold. The other is a method for determining that the optical image is defective when a ratio of a line width of the pattern in the reference image and a line width of the pattern in the optical image exceeds a predetermined threshold. The latter may be aimed at a ratio of the distance between the patterns in the reference image and the distance between the patterns in the optical image. At this point, the optical image captured with the sensor 1011 is suitable for the inspection in which the size of the pattern is measured, because the optical image has the high contrast between the white and black portions of the optical image.

As described above, according to the inspection apparatus of the present embodiment, the pattern of the optical resolution limit or less can be inspected using the optical image captured with the sensor 1010. That is, using the optical image, the fine pattern can accurately be inspected without the throughput degradation. Additionally, according to the optical system in FIG. 1, the pattern of the optical resolution limit or more can be inspected using the optical image captured with the sensor 1011. That is, in the inspection apparatus, it is not necessary that the pattern of the optical resolution limit or more and the pattern of the optical resolution limit or less be inspected separately, but the pattern of the optical resolution limit or more and the pattern of the optical resolution limit or less can be inspected within one process.

In the fourth embodiment, the inspection apparatus 100 includes the optical system as shown in FIG. 1. Alternatively, instead of said optical system, the inspection apparatus 100 may include the optical system in FIG. 7 or FIG. 8. In this case, the advantageous effect of the fourth embodiment is obtained. In the case that the inspection apparatus 100 includes the optical system in FIG. 8, the angle of the polarization beamsplitter is adjusted by an angle adjusting unit to control the polarization direction of the light incident to the sensor that captures the optical image used to inspect the pattern of the optical resolution limit or less. The angle adjusting unit corresponds to the angle control circuit 14 in FIG. 9. At this point, in the dark-field illumination system, the angle of the polarization beamsplitter is set to one at which the standard deviation of the gradation value obtained by the image processor 108 becomes the minimum. In the bright-field illumination system, the angle of the polarization beamsplitter is set to one at which the value in which the standard deviation of the gradation value in the optical image, which is acquired while the angle of the polarization beamsplitter is changed, is divided by the square root of the average gradation value obtained from the gradation value becomes the minimum.

The present invention is not limited to the embodiments described and can be implemented in various ways without departing from the spirit of the invention.

In the above embodiments, the sample is illuminated with the light emitted from the light source, and the light reflected from the sample is incident to the sensor to capture the optical image. Alternatively, the light transmitted through the sample may be incident to the sensor to capture the optical image. The above description of the present embodiment has not specified apparatus constructions, control methods, etc., which are not essential to the description of the invention, since any suitable apparatus construction, control methods, etc. can be employed to implement the invention. Further, the scope of this invention encompasses all inspection apparatus employing the elements of the invention and variations thereof, which can be designed by those skilled in the art.

What is claimed is:

1. An inspection apparatus comprising:
a light source configured to illuminate a sample which is an inspection target;
a half-wavelength plate configured to transmit the light transmitted through or reflected from the sample;
a polarization beamsplitter configured to transmit the light transmitted through the half-wavelength plate;
a first sensor configured to receive the light as a first optical image transmitted through the polarization beamsplitter;
a second sensor configured to receive the light as a second optical image reflected from the polarization beamsplitter;
an image processor configured to obtain a gradation value of each pixel of the first sensor with respect to the first optical image captured with the first sensor;
a defect detector configured to detect a defect of the first optical image captured with the first sensor, using the gradation value; and
a comparator configured to compare the second optical image of a pattern captured with the second sensor to a reference image which is an image generated based on design data or an image captured by photographing the same pattern, and to determine that the second optical image is defective when at least one difference of position and shape between the optical image and the reference image exceeds a predetermined threshold,
an angle adjusting unit configured to adjust an angle of the half-wavelength plate to control a polarization direction of the light incident to the first sensor.

2. The inspection apparatus according to claim 1,
wherein the light irradiated from the light source is linearly-polarized light, and
a quarter-wavelength plate is arranged on an optical path toward the sample from the light source;
and another quarter wavelength plate is arranged on an optical path toward the half-wavelength plate from the sample.

3. The inspection apparatus according to claim 1,
wherein the light irradiated from the light source is linearly-polarized light, and
a quarter-wavelength plate is arranged on a shared optical path, wherein the shared optical path is a section of an optical path toward the sample from the light source, and a section of an optical path toward the half-wavelength plate from the sample.

4. The inspection apparatus according to claim 1,
wherein the light irradiated from the light source is linearly-polarized light, and
the half-wavelength plate is arranged on an optical path toward the sample from the light source.

5. The inspection apparatus according to claim 1, wherein a light quantity adjustor is arranged on an optical path toward the second sensor from the polarization beamsplitter.

6. The inspection apparatus according to claim 1, wherein the angle of the half-wavelength plate is set to one of an angle at which a standard deviation of the gradation value obtained by the image processor becomes the minimum and an angle at which a value in which the standard deviation of the gradation value, which is obtained while the angle of the half-wavelength plate is changed, is divided by a square root of an average gradation value obtained from the when the gradation value becomes the minimum.

7. The inspection apparatus according to claim 1, wherein the defect detector compares the gradation value output from the image processor to a predetermined threshold, and detects the defect when the gradation value exceeds the threshold.

8. An inspection apparatus comprising:
a light source configured to illuminate a sample which is an inspection target;
a branching element that branches the light emitted from the light source;
a polarization beamsplitter configured to transmit the light transmitted through or reflected from the sample is incident, the light being one of light branched by the branching element;
a first sensor configured to receive the light as a first optical image transmitted through the polarization beamsplitter;
a second sensor configured to receive the light as a second optical image transmitted through or reflected from the sample, the second light being the other light branched by the branching element;
an image processor configured to obtain a gradation value of each pixel of the first sensor with respect to the first optical image captured with the first sensor;
a defect detector configured to detect a defect of the first optical image captured with the first sensor, using the gradation value; and
a comparator configured to compares the second optical image of a pattern captured with the second sensor to a reference image which is an image generated based on design data or an image captured by photographing the same pattern, and to determine that the second optical image is defective when at least one a difference of position and shape between the optical image and the reference image exceeds a predetermined threshold,
an angle adjusting unit configured to adjust an angle of the polarization beamsplitter to control a polarization direction of the light incident to the first sensor.

9. The inspection apparatus according to claim 8,
wherein the light irradiated from the light source is linearly-polarized light, and
a quarter-wavelength plate is arranged an optical path toward the sample from the branching element; and another quarter wavelength plate is arranged on an optical path toward the polarized beam splitter from the sample.

10. The inspection apparatus according to claim 8,
wherein the light irradiated from the light source is linearly-polarized light, and
a quarter-wavelength plate is arranged on a shared optical path, wherein the shared optical path is a section of an optical path toward the sample from the branching element, and a section of an optical path toward the polarized beam splitter from the sample.

11. The inspection apparatus according to claim 8,
wherein a half-wavelength plate is arranged on an optical path toward the branching element from the light source, and
a ratio of quantities of light branched by the branching element is adjusted by the angle of the half-wavelength plate.

12. The inspection apparatus according to claim 8, wherein the angle of the polarized beam splitter is set to one of an angle at which a standard deviation of the gradation value obtained by the image processor becomes the minimum and an angle at which a value in which the standard deviation of the gradation value, which is obtained while the angle of the polarized beam splitter is changed, is divided by a square root of an average gradation value obtained from when the gradation value becomes the minimum.

13. The inspection apparatus according to claim 8, wherein the defect detector compares the gradation value output from the image processor to a predetermined threshold, and detects the defect when the gradation value exceeds the threshold.
